(19) United States
(12) Patent Application Publication
(10) Pub. No.: US 2009/0265739 A1
(43) Pub. Date: Oct. 22, 2009

(54) METHOD AND SYSTEM FOR CHANNEL SELECTION IN A DIGITAL BROADCAST RECEPTION TERMINAL

(75) Inventors: Prabhjot Singh ARORA, New Delhi (IN); Kaushik Saha, Delhi (IN)

Correspondence Address: HOGAN & HARTSON LLP, ONE TABOR CENTER, SUITE 1500, 1200 SEVENTEENTH ST, DENVER, CO, 80202, US

(73) Assignee: STMicroelectronics Pvt. Ltd., Greater Noida (IN)

(21) Appl. No.: 12/105,834

(22) Filed: Apr. 18, 2008

(51) Int. Cl. H04N 5/445; G06F 13/00; H04N 7/173

(52) U.S. Cl. 725/43; 725/39; 725/131; 725/46; 348/731

(57) ABSTRACT

The present invention discloses a system and method for channel selection in a digital broadcast reception terminal. The system tunes to different frequencies and generates visual clips corresponding to a plurality of channels in a frequency band. Visual clips of multiple channels are simultaneously displayed on a display screen which provides the user an easy way to select a desired program.

### FIELD OF THE INVENTION

The present invention relates to the field of digital broadcast reception systems. In particular, the invention discloses a novel method for channel selection in a digital broadcast reception terminal.

### BACKGROUND OF THE INVENTION

With the advent to cable television, a large number of commercial television channels were launched in the last two decades. The number of channels has become so large that an average TV viewer has to spend a significant amount of time just searching for the program that he may want to see. The user has to visit all channels one by one to check the program running on them. There is no good mechanism available that can help in fast channel selection. This factor significantly affects the overall television viewing experience. Frequent channel changing also puts a lot of strain on the eyes of viewer and also causes unnecessary wear and tear on the television system components.

One solution proposed in the prior art to this problem is to send “program identifier information” containing details like title, cast, program type, etc. for each program along with the program signal. The program information from each program running at any given time on different channels is used to construct a program guide.

U.S. Pat. No. 5,867,207 discloses one such program guide shown in FIG. 1, which contains the list of programs available on various channels at different times. The user can read this textual information to select a program he may want to see.

An improved version of the above mentioned program guide is the theme based program guide. FIG. 2 of U.S. Patent Publication No. 2005/0160456 illustrates a theme based program guide in which a list of all the available programs falling under a common theme like news or sports is displayed. The user can scroll through the entire program guide and choose a program of interest.

Although the above mentioned electronic program guides provide the basic program information for channel selection, there are several shortcomings to these guides. Through these guides, the user makes a selection based only on the textual information corresponding to each program available in the program guide. However, in many cases this textual information may be insufficient to select the desired channel. For example, the user may get information from program guide that a specific program on health education is currently running on a particular channel, however he has no information if at that specific instance of time the actual program is running or an advertisement is running on the television. Moreover, it becomes very time consuming and tedious to read the program information of so many different channels to get information on all the programs running at any given moment. Furthermore, viewers often want to see a program set up or view a program's host before making a decision to view a specific channel. This is not possible using only the textual information provided by existing program guides.

These very significant limitations of currently available program guides discourage many users from regularly using such program guides. Instead, viewers may frequently change channels to see a short visual display of each channel on the television screen before making a decision to view a specific channel. This strategy of frequently changing channels for selecting a specific channel puts a lot of strain on the eyes of user and also leads to wastage of time. Further, frequent changing of channels reduces the life of the television system.

Therefore, there is a need for some system/method of channel selection which would remove above mentioned shortcomings and would provide an easy way to determine which programs are running on all channels, to improve the overall viewing experience.

### SUMMARY OF THE INVENTION

It is an object of the present invention to provide a system and methodology for channel selection in the digital broadcasting reception terminal.

It is another object of the present invention to provide a system of channel selection in which visual information corresponding to each channel is provided to the user to make channel selection.

To achieve the aforementioned objectives, the present invention provides a system that generates visual clips corresponding to different channels and store these visual clips in a memory to construct a program guide. The system sequentially tunes to different frequencies and generate the visual clips for a plurality of the channels in the respective frequency bands. On receiving instruction from the viewer, visual clips of several channels are simultaneously displayed on the display screen to provide the user an easy way to make a program selection. The visual clips are regularly updated when the new picture data is generated for the channels. In a preferred embodiment, the system uses multiple tuning and demodulating systems and generates the visual clips only for the channels present in the favorite list of the user so that the time lag between two successive updating of visual clip for a specific channel may be minimized.

### BRIEF DESCRIPTION OF DRAWINGS

The aforementioned aspects and other features of the present invention will be explained in the following description, taken in conjunction with the accompanying drawings, wherein:

FIG. 1 illustrates an electronics program guide disclosed in the prior art.

FIG. 2 illustrates another electronic program guide disclosed in the prior art.

FIG. 3 illustrates a block diagram of digital broadcasting reception device according to the method of an embodiment of the present invention.

FIG. 4 illustrates a block diagram of the digital broadcasting device according to an embodiment of the present invention.

FIG. 5A illustrates the display screen according to an embodiment of the present invention.

FIG. 5B illustrates the display screen according to other embodiment of the present invention.

FIG. 6 illustrates the display screen according to an embodiment of the present invention

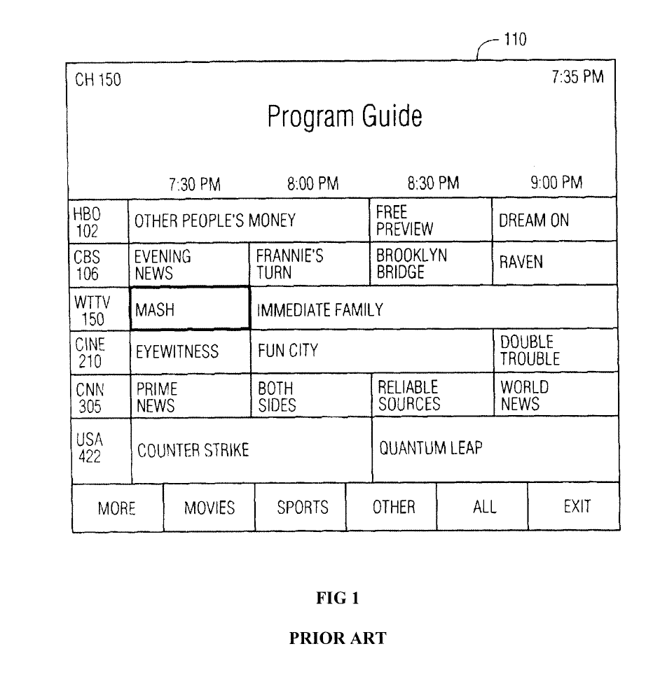

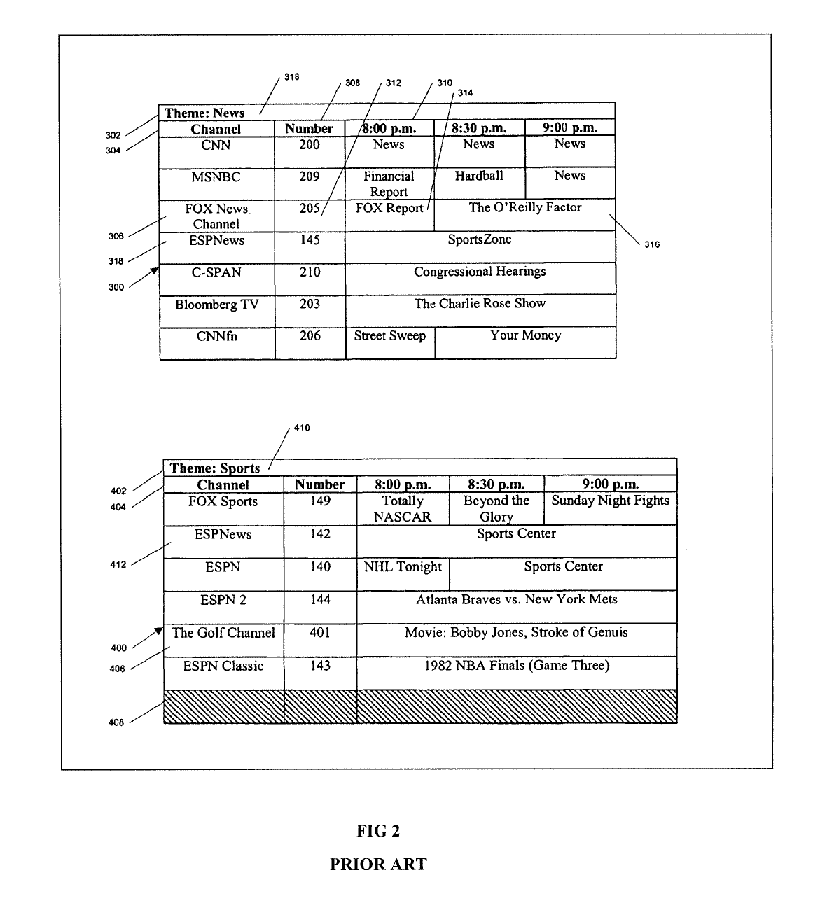

### DETAILED DESCRIPTION OF PREFERRED EMBODIMENTS

The present invention discloses a system and method for channel selection which does not require frequent changing of channels to know the programs running on other channels at any given instance of time.

According to an embodiment of the present invention, the viewer is provided the option to visually check the programs running on different channels without changing the channels one by one. The television screen displays visual clips (also referred to as the “picture data” or “thumbnails”) from a large number of channels grouped together in the same display screen. With a quick glance at the screen, the viewer is able to identify a plurality of the programs running on different channels. Preferably, the view is able to identify all of the programs running on different channels or a selected subset of the programs running on all the different channels.

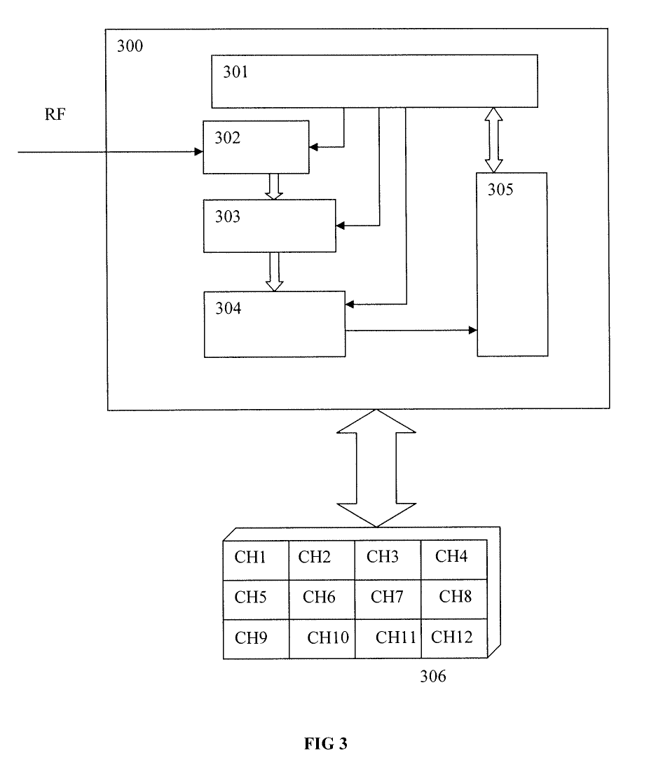

The system disclosed in FIG. 3 is used to describe the methodology according to an embodiment of the present invention. The system disclosed in FIG. 3 basically shows the main components of the basic digital broadcasting reception device. One of ordinary skill in the art would appreciate that the digital broadcast reception device mentioned in this invention could be any kind of reception device like a set top box, a television or a mobile unit enabled to receive digital video broadcast (DVB) signals. The unit 300 comprises all the electronics hardware, software and other components present in a reception device. A control unit 301 controls the overall operation inside the reception device. System 300 receives analog RF signal as an input. A tuning unit 302 functions to tune the system to a specific incoming frequency signal so that the channels corresponding to that frequency could be demodulated and selected for viewing. Demodulating unit 303 demodulates the incoming signal to generate encoded digital video bit stream. The output of demodulator 303 usually contains video data of several programs that are running on different channels in the same frequency band. The various arrows of FIG. 3 represent the data communication between different components.

A decoder 304 decodes the encoded video bit stream of several programs to generate video data for specific programs. The program I.D. of the specific program is used by the decoder to decode the encoded video data of that program.

A system memory 305 stores the data while different operations are performed inside the reception device. A display screen 306 displays the final output of reception device

During operation, after the reception device receives a channel selection instruction from the viewer, tuning unit 302 starts tuning the system to different incoming frequencies, one by one. Tuning unit may take some time to tune to each frequency, up to one second for each frequency.

In digital video transmission, one physical channel (i.e., the frequency band) usually carries signals corresponding to multiple channels from the same service provider. The number of channels in a specific frequency band varies and is usually in the range of 10-15. When tuning unit 302 is tuned to a specific frequency band, after demodulation of incoming signal, the encoded video bit stream is preferably decoded to generate the picture data for all the programs running on the channels in that frequency band. Picture data corresponding to each channel is stored in system memory 305 to construct an electronic program guide containing visual information corresponding to all available channels. The visual clips (the picture data) for a specific number of programs are then displayed simultaneously on display screen 306. The system then tunes to the next frequency and subsequently generate the visual clips for the channels available in that frequency band.

The term “visual clip” as used herein means a subset of the frames from a program, preferably from 1-10 frames from a program, and most preferably, just a few frames (i.e., 1-4) from a program

As shown in FIG. 3, the visual clips of 12 different channels (CH1, CH2 . . . CH12) are reduced in size and displayed on the same display screen. The number of channels for which the picture data will be displayed in one screen may be fixed to a specific value (e.g., 8 or 12) depending upon the size of the display screen. In a preferred embodiment of the invention the user is provided with the option to change the number of channels to be displayed on the screen as per his convenience.

In a few seconds the system sequentially generates the visual clips for all or a predetermined plurality of the available channels. While the visual clips from about 8-12 channels are displayed on the screen at any given moment, the picture data corresponding to other channels is stored in memory 305 and the user is able to scroll through the visual clips of remaining channels by pressing a specific button on the remote control unit.

It is pertinent to mention here that after preferably, after completing the generation of picture data for all channels, the system continues the process of sequentially tuning to all available frequencies to generate visual clips for all channels in such frequency bands until the user makes a selection. For any given channel, when the new picture data is generated, the old picture data for that channel is replaced with the new picture data. Assuming that there are about eighty to hundred channels in the incoming RF signal, it is expected to take one to a few seconds for the picture data for any one channel to be updated.

With the present invention, it becomes very easy for the viewer to make a channel selection as he can simultaneously check the latest visual clips/thumbnails of the programs running on multiple channels. Just by having a glance on any visual clip, the user can identify the program running on that channel and determine whether it is a news program, an action movie, or some other program, or whether it is in commercial. Compared to techniques in the prior art in which textual information corresponding to each program is provided to construct a program guide, the present invention makes the channel selection very fast and less cumbersome. With the visual monitoring of the channels, it becomes very fast and easy for the viewer to take decision on the channel that he or she may want to watch as compared to reading the textual information in the currently available program guides.

In a preferred embodiment of the present invention, after generating the visual clips of different channels, the system has a mechanism to identify visual clips that would not be very useful to identify a program. For example, if in the few frames of picture data gathered from a specific channel only blue sky is visible, the user may not understand which program is running on that channel. In such cases the system may incorporate a mechanism to display a blank screen in the area corresponding to that channel until a new visual clip is generated for that channel from which the program could be identified more accurately.

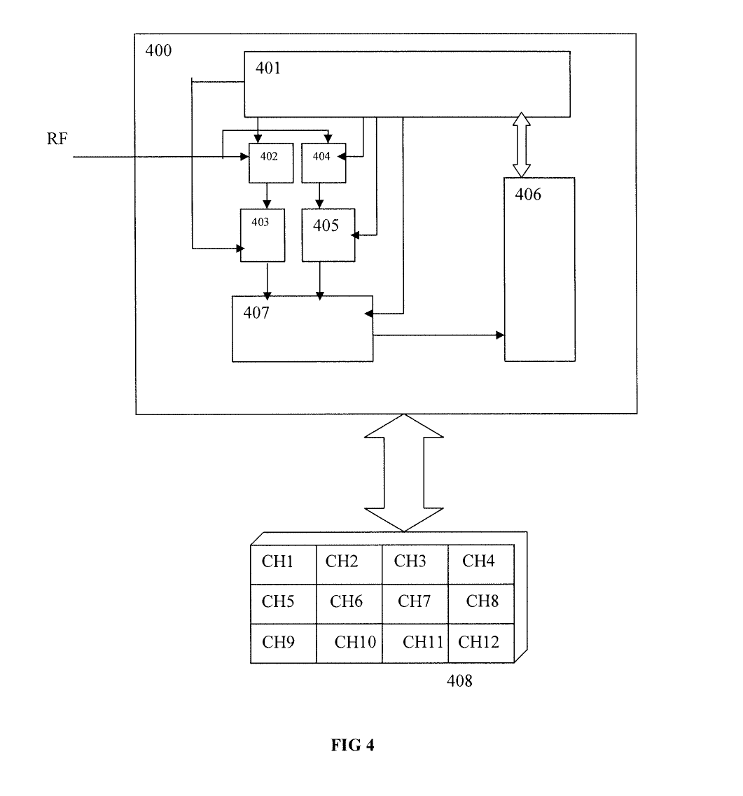

FIG. 4 discloses another embodiment of reception device as disclosed in the present invention. In this embodiment, the system uses two tuning units and two demodulators which are dedicated to different operations. A system 400 comprises a control unit 401 that controls the entire operation in the reception device. The system includes system memory 406, two tuning units 402 and 404, two demodulators 403 and 405, and a decoder 407. The first tuning unit 402 and the demodulator 403 are used to generate the video data from the channel which the viewer has selected for watching at any given moment. The second tuning unit 404 and the demodulator 405 continuously operate in the background to generate visual clips for other channels. Tuning unit 404 sequentially tunes to different frequencies. After demodulation of the incoming signal by demodulator 405, the picture data corresponding to the channels in a specific frequency band are decoded sequentially by the decoder 407. This picture data corresponding to multiple channels is stored in the memory 406 to dynamically construct a visual electronic program guide. When the viewer issues the instruction for channel selection mode, the visual clips (the picture data) corresponding to other channels, which are already stored in the memory 406 are displayed on the display screen 408. The viewer can scroll through the screen to check visual clips of all the available channels and can make the channel selection.

In an alternate embodiment of the present invention, the system includes multiple tuner and demodulator modules and even multiple decoding units to reduce the time lag between subsequent generations of picture data (visual clips) for any given channel. Multiple tuning modules help in faster processing and helps to reduce the time lag between two successive updating of visual clip for a specific channel. The time that is wasted in single tuner system when the same tuner tunes to multiple frequencies one by one is saved in multiple tuner systems. While one tuning unit is used for running the program on the channel selected by the user, all the other tuning units sequentially tune to different frequencies, generate picture data corresponding to the channels in a specific frequency band and stores the said picture data in the system memory 406 in the form of a program guide.

In a preferred embodiment of the present invention, the name of the program is also displayed below its visual clip on the screen. While the user can identify most of the programs just by looking on the visual clips, in some cases the name of the program is also essential to accurately identify the program. For example, the user can identify a news program accurately from the visual clip; however in case of a movie program the user would need the name of the movie to accurately identify the program.

In another preferred embodiment of the present invention, the viewer is provided with the facility to check detailed information about any program by just selecting the visual clip corresponding to that program and pressing a specific button on the remote control unit. This capability would be very useful in cases where the user would want more information about a specific program before making a decision to watch that program. For example, in case the user may want to know all the actors in a movie before wanting to start watching the movie. This embodiment basically combines the visual technique as disclosed in the present invention with the textual techniques as disclosed in the prior art to provide a better viewing experience to the user.

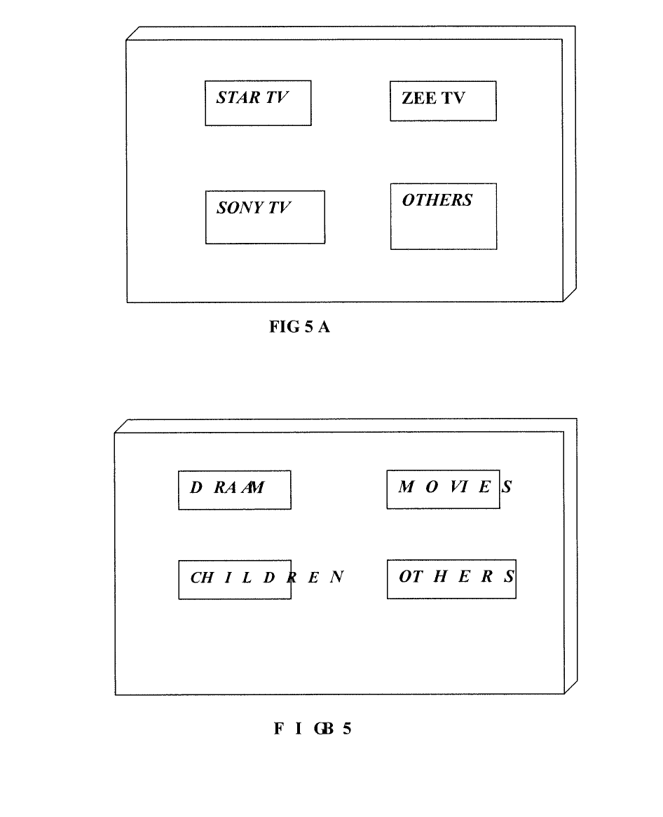

In one alternate embodiment of the present invention, the system distinguishes the programs on the basics of service provider and the type of program. Hierarchal graphical menu is provided and the visual clips of channels under a specific item can be viewed together. When the user issues the instruction for channel selection, multiple icons are displayed on the television screen as shown in FIG. 5A. In FIG. 5A, three different icons are shown corresponding to STAR TV, ZEE TV, SONY TV which are major television service providers in India. Each of these service providers provide many channels in their bouquet. The viewer can select any one service provider and check visual clips of all the channels provided by this service provider. The advantage of this approach is that the visual clips are generated very fast in this scheme as a lot of channels from any one service provider are usually transmitted in the same frequency band and the tuner module does not have to tune to different frequencies to generate the visual clips from multiple channels. The system has to just change the program ID to access the different programs contained in same frequency band.

In one other embodiment of the present invention, each of the television service providers transmit a specific channel which just contains the thumbnails of programs running on other channels by that service provider. In this embodiment, the requirement for dynamic construction of visual program guide by storing picture data of each channel would be eliminated.

In one other embodiment, when the user selects a specific service provider in the screen shown in FIG. 5A, the screen shown in FIG. 5B is displayed in which different categories are mentioned like DRAMA, MOVIES, CHILDREN etc. The user can select a specific category to view all the channels provided by a specific service provider in the respective category.

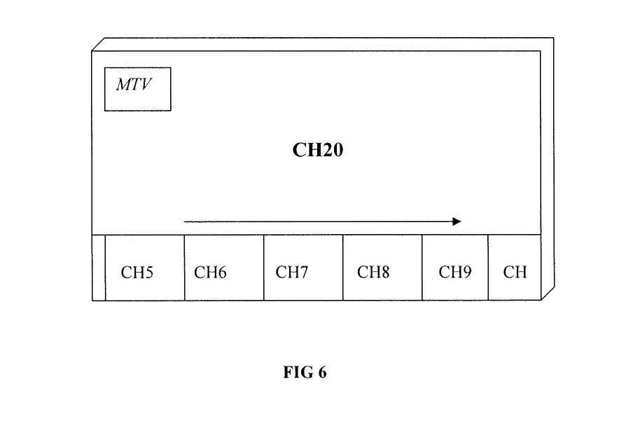

In one other embodiment of the invention shown in FIG. 6, the user is given an option to enable a horizontal bar containing visual clips at the bottom of the screen while viewing any one regular channel. On receipt of corresponding instruction from the viewer the system displays a bar in which visual clips of the other channels are scrolled. The user can keep a track on other programs so that he can switch the channel if he finds some other program more interesting. For example as illustrated in the FIG. 6, the normal channel running on the screen is CH20 (channel 20) which is shown as MTV. In the bottom of the screen the visual clips from other channels are scrolling for the user to track the programs running on other channels.

In one preferred embodiment of the present invention, the user is given the option to construct a favorite channel list. While there are a large number of commercially available channels, an average user just see about 20-30 channels regularly. The user can make a favorite channel list which can be stored in the system. The system is configured in such a manner that either in the backend or on receiving the user instruction for channel selection, the system generates the visual clips just for the channels stored only in the favorite channel list. In this embodiment the system is able to generate the visual program guide very fast. Using multiple tuners and generating clips only for favorite channels could provide the results somewhat close to real time situation wherein all the visual clips displayed on the display screen would update so fast that the user would perceive very less discontinuity in the programs.

Although the disclosure of architecture and method has been described in connection with the embodiment of the present invention as illustrated in the accompanying drawings, it is not limited thereto. It will be apparent to those skilled in the art that various substitutions, modifications and changes may be made thereto without departing from the scope and spirit of the invention.

1. A method of channel selection in a digital broadcast reception device, the method comprising:
sequentially tuning to a plurality of frequency bands in an incoming RF signal, each of the plurality of frequency bands comprising signals relating to a plurality of embedded channels;
demodulating the signals in at least one of the plurality of frequency bands;
decoding the plurality of embedded channels in the at least one of the plurality of frequency bands;
storing picture data corresponding to a visual clip for each of the plurality of decoded channels in a memory register;
displaying the stored picture data for a plurality of the decoded channels on the display terminal upon receiving an instruction to display a visual electronic program guide; and
dynamically updating the visual electronics program guide unless the system is instructed otherwise.

2. A method of channel selection as claimed in claim 1, wherein the length of stored picture data for each channel is a few frames.

3. A method of channel selection as claimed in claim 1, wherein the channels to be decoded and included in the visual electronic program guide are predetermined by the user.

4. A method of channel selection as claimed in claim 1, wherein the visual electronic program guide is pre-constructed by system components running in the background while one of the plurality of channels is displayed on the display screen.

5. A method of channel selection as claimed in claim 1, wherein on receiving the instruction to display the visual electronic program guide, the guide is constructed in run time.

6. A digital broadcast reception device comprising:
a frequency tuner for tuning the system to different incoming frequency signals;
a demodulator for demodulating the incoming signals and generating an encoded video bit stream for various channels;
a video decoder for generating video data from the encoded video signals;
a display;
a user operated control unit for operating the display in a regular mode or in a channel selection mode having a visual electronic program guide comprising visual clips of a plurality of the various channels; and
a memory register to store the visual electronic program guide.

7. A digital broadcast reception device as claimed in claim 6, wherein while operating in the channel selection mode, the system sequentially tunes to different frequency bands and generates picture data to support the visual clips and corresponding to different channels for constructing the visual electronic program guide at run time.

8. A digital broadcast reception device as claimed in claim 6, wherein the user operated control unit includes a remote control unit.

9. A digital broadcast reception device comprising:
a frequency tuner for tuning the system to different incoming frequency signals;
a demodulator for demodulating the incoming signals and generate encoded video bit stream for various channels;
a video decoder for generating video data from the encoded video signals;
a display; and
a memory register for storing a visual electronic program guide comprising a subset of incoming picture data for a plurality of the various channels.

10. A digital broadcast reception device as claimed in claim 9, further comprising at least one spare decoding unit for sequentially decoding the incoming video bit stream solely for the purpose of constructing the visual electronic guide.

11. A digital broadcast reception device as claimed in claim 9, wherein the said memory register is continuously updated with incoming picture data corresponding to the plurality of channels.

12. A method of channel selection in a digital broadcast reception device, the said method comprising the steps of:
tuning the system sequentially to various frequency bands in an incoming RF signal;
demodulating the signals in each frequency band;
decoding the channels embedded in a specific frequency band;
storing a short duration of picture data corresponding to each of the decoded channels in a memory register for constructing a visual electronic program guide;
on receiving the user instruction, displaying the picture data from visual electronic program guide for several channels together in a separate horizontal bar/frame simultaneously along with the regular channel data on the display terminal; and
continuously updating and running the picture data for different channels in the horizontal bar unless the user instructs otherwise.

13. A method of channel selection as claimed in claim 12, wherein the channels to be decoded and included in the visual electronic program guide are predetermined by the user.

14. A method of channel selection as claimed in claim 12, wherein said horizontal bar is displayed at the bottom or top of the display screen.

15. A method of channel selection in a digital broadcast reception device, the method comprising:
receiving user instructions for displaying picture data/thumbnails corresponding to all the channels from a specific television service provider;
tuning the system to the frequency band corresponding to that specific television service provider in the incoming RF signal;
demodulating the signals in that frequency band;
decoding the channels embedded in the specific frequency band;
storing a short duration of picture data corresponding to each of the decoded channel in a memory register;
displaying the stored picture data for several channels in a single frame on the display terminal; and
dynamically updating the picture data/thumbnail of stored channels unless the user instructs otherwise.

16. A method of channel selection in a digital broadcast reception device, the method comprising:
tuning the system sequentially to frequency bands corresponding to various television service providers in an incoming RF signal;
demodulating the signals in each frequency band;
decoding the channels embedded in a specific frequency band;
storing a short duration of picture data corresponding to each of the decoded channels in a memory register for constructing a visual electronic program guide;
displaying the stored picture data for all the channels corresponding to a specific television service provider on receiving the user instruction for the same; and
continuing the dynamic update of visual electronic program guide with latest picture data of channels.
